(19) United States
(12) Patent Application Publication
(10) Pub. No.: US 2023/0292798 A1
(43) Pub. Date: Sep. 21, 2023

(54) METHOD OF MANUFACTURING INSTANT NOODLES

(71) Applicant: A-SHA REPUBLIC INC., TAIPEI CITY (TW)

(72) Inventor: TA-WEI LO, TAIPEI CITY (TW)

(21) Appl. No.: 17/696,836

(22) Filed: Mar. 16, 2022

(51) Int. Cl. A23L 7/113; A23L 3/40; A23L 5/10

(52) U.S. Cl. CPC A23L 7/113; A23L 3/40; A23L 5/13; A23V 2002/00

(57) ABSTRACT

The method of manufacturing instant noodles includes: mixing a noodle base material, water, and salt into a mixture; extruding the mixture into noodles of appropriate width, thickness, and shape; steaming the noodles; cutting the noodles after the noodles are steamed; half-puff or fully puff drying the noodles after they are cut, based on the thickness of the noodles and the expected cook or soak time Finally, instant noodles that are easy to cook and soak are formed. The noodle base material includes flour, semolina or durum wheat flour.

### BACKGROUND OF THE INVENTION

### (a) Technical Field of the Invention

The present invention is generally related to instant noodles, and more particular to a method of manufacturing instant noodles.

### (b) Description of the Prior Art

Instant noodles are widely popular in Asian region. Instant noodles are precooked and seasoned noodles that are subsequently dried and formed into noodle blocks. Instant noodles can be consumed after being cooked or soaked in boiling water for only a few minutes. The noodles are made from wheat flour together with water, salt, and some ingredients. There are different types of noodles of various thickness or width. Thicker noodles take more time to cook or soak. Thinner noodles, on the other hand, take less time. Without properly control the timing, the flavor of the instant noodles would be compromised.

Italian pastas refer to all noodles made from flour and water, sometimes with eggs. Specifically, Italian pastas are made from durum wheat flour or semolina. More generally, Italian pastas includes noodles made from other cereals. Italian pastas have many styles such as the long and thin Spaghetti, the thicker and flatter Linguine, the thinnest Angel Hair, the twisted Fusilli, etc. Other than Italy and Europe, Italian pastas are also widely popular in other parts of the world. Italian pastas are usually cooked for a longer period before consumption (usually between 8˜13 minutes), and the noodles are harder in texture. Therefore, it is more difficult to make Italian pastas into instant noodles.

### SUMMARY OF THE INVENTION

A major objective of the present invention, therefore, is to provide a manufacturing method of instant noodles so that they are quickly consumable after a short period of cook or soak time, regardless of their thickness. The method of manufacturing instant noodles includes: mixing a noodle base material, water, and salt into a mixture; extruding the mixture into noodles of appropriate width, thickness, and shape; steaming the noodles; cutting the noodles after the noodles are steamed; half-puff or fully puff drying the noodles after they are cut, based on the thickness of the noodles and the expected cook or soak time Finally, instant noodles that are easy to cook and soak are formed.

Specifically, the mixture includes 77% of noodle base material, 21%˜22% of water, and 1%˜2% of salt.

Specifically, the noodle base material includes flour.

Specifically, the noodle base material includes semolina or durum wheat flour.

Specifically, in the steaming step, the noodles are 100% steamed.

The half-puff drying includes a first stage of drying conducted using warm air of 120° C.˜150° C. blown at speed 10 m/s for a minute, a second stage of drying conducted using warm air of 80° C. blown at speed 10 m/s for 36 minutes, and a third stage involving placing the noodles in a closed space for 15 minutes to achieve uniform drying.

The fully puff drying includes a first stage of drying conducted using warm air of 150° C.˜2000° C. blown at speed 10 m/s for a minute, a second stage of drying conducted using warm air of 80° C. blown at speed 10 m/s for 36 minutes, and a third stage involving placing the noodles in a closed space for 15 minutes to achieve uniform drying.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing a method of manufacturing instant noodles according to an embodiment of the present invention.

FIG. 2 is a flow diagram showing the details of a step S12 of the method of manufacturing instant noodles of FIG. 1.

FIG. 3 is a perspective diagram showing a noodle before a half-puff drying of the present embodiment.

FIG. 4 is a partially enlarged diagram showing a noodle after a half-puff drying of the present embodiment.

FIG. 5 is a flow diagram showing a method of manufacturing instant noodles according to another embodiment of the present invention.

FIG. 6 is a flow diagram showing the details of a step S22 of the method of manufacturing instant noodles of FIG. 5.

FIG. 7 is a perspective diagram showing a noodle before a fully puff drying of the present embodiment.

FIG. 8 is a partially enlarged diagram showing a noodle after a fully puff drying of the present embodiment.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

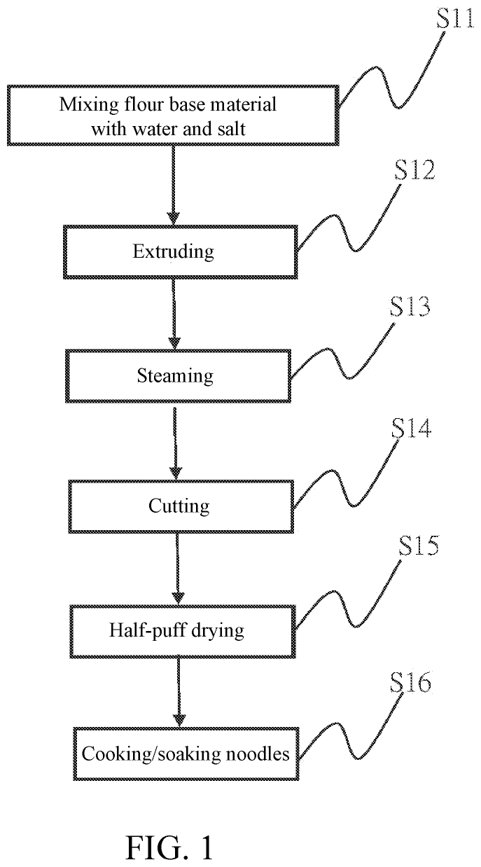

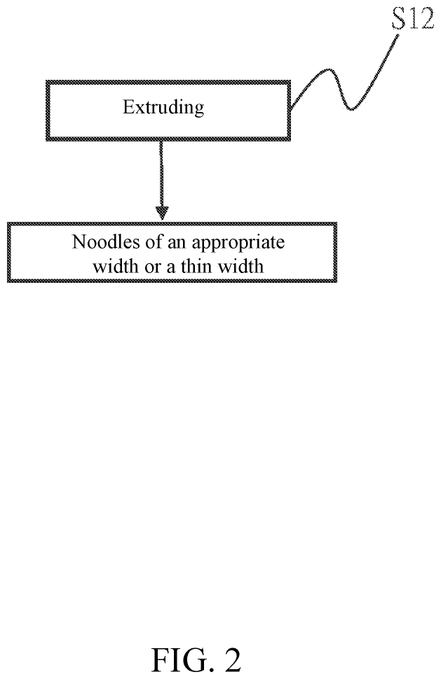

As shown in FIG. 1 and FIG. 2, a method of manufacturing instant noodles according to an embodiment of the present invention includes the following steps:
1. Mixing about 77% of noodle base material, about 21%˜22% of water, and about 1%˜2% of salt, where, in the present embodiment, the noodle base material includes about 100-kg flour, semolina or durum wheat flour, and about 30-kg water and salt (step S11);
2. Extruding the mixture of noodle base material, water, and salt into noodles where, in the present embodiment, molds are applied to produce elongated noodles of an appropriate width, or thinner Italian pastas such as Angel Hair pastas; (step S12);
3. 100% steaming the extruded noodles thoroughly (step S13);
4. Cutting the steamed noodles (step S14);
5. Half-puff drying the steamed and cut noodles, where, in the present embodiment, a first stage of drying is conducted using warm air of 120° C.˜150° C. blown at speed 10 m/s for a minute, a second stage of drying is conducted using warm air of 80° C. blown at speed 10 m/s for 36 minutes, and finally a third stage involves placing the noodles in a closed space for 15 minutes to achieve uniform drying (step S15); and
6. Forming instant noodles that are easy to cook and soak (step S16).

In the above process, the condition for the drying step may vary depending on the thickness of the noodles and the cook or soak time. When making noodles of a medium thickness (or Spaghettis or Angel Hairs), the drying condition allows the noodles to maintain their shapes with small pores. When the noodles are cooked or soaked, water would slowly enter the pores and the noodles would not be overdone.

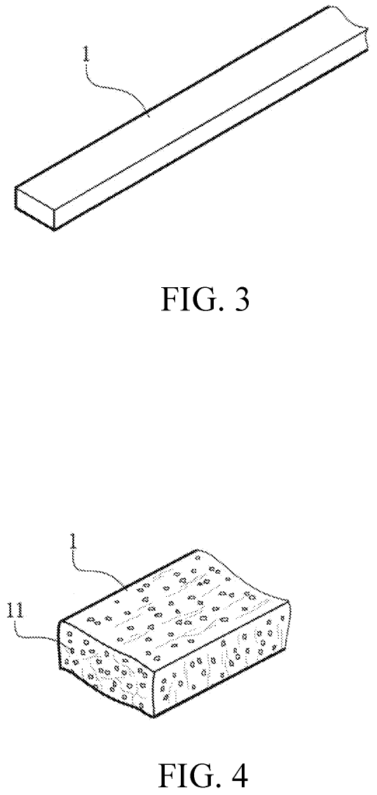

As shown in FIG. 3, the noodles 1 before drying have a smooth shape without creases and pores. Then, as shown in FIG. 4, the noodles 1 after drying would have a same shape but there would be multiple randomly distributed pores 11 across the cross section. Due to their small aperture, water would slowly enter the pores and the noodles would not be overdone when they are cooked or soaked.

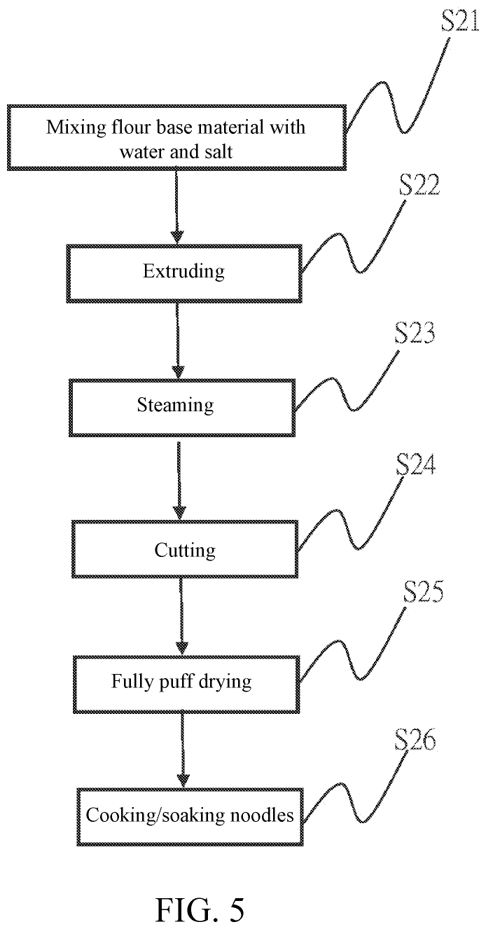

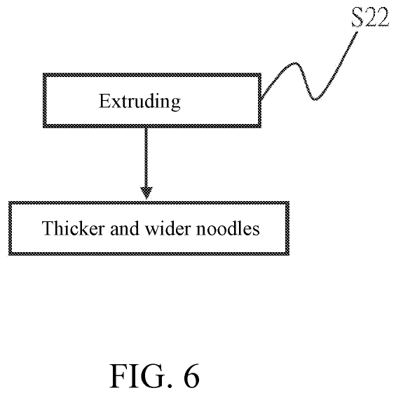

As shown in FIG. 5, and FIG. 6, a method of manufacturing instant noodles according to another embodiment of the present invention includes the following steps:
1. Mixing about 77% of noodle base material, about 21%˜22% of water, and about 1%˜2% of salt, where, in the present embodiment, the noodle base material includes about 100-kg flour, semolina or durum wheat flour, and about 30-kg water and salt (step S21);
2. Extruding the mixture of noodle base material, water, and salt into noodles where, in the present embodiment, molds are applied to produce thicker and wider noodles, or wider Italian pastas such as Linguine pastas; (step S22);
3. 100% steaming the extruded noodles (step S23);
4. Cutting the steamed noodles (step S24);
5. Fully-puff drying the steamed and cut noodles, where, in the present embodiment, a first stage of drying is conducted using warm air of 150° C.˜2000° C. blown at speed 10 m/s for a minute, a second stage of drying is conducted using warm air of 80° C. blown at speed 10 m/s for 36 minutes, and finally a third stage involves placing the noodles in a closed space for 15 minutes to achieve uniform drying (step S25); and
6. Forming instant noodles that are easy to cook and soak (step S16).

In the above process, the condition for the drying step may vary depending on the thickness of the noodles and the cook or soak time. When making wider and thicker noodles, the drying condition allows the noodles to puff up with large pores. When the noodles are cooked or soaked, water would quickly enter the pores and the noodles would not be too hard or overdone if the cook or soak time is not enough or too long.

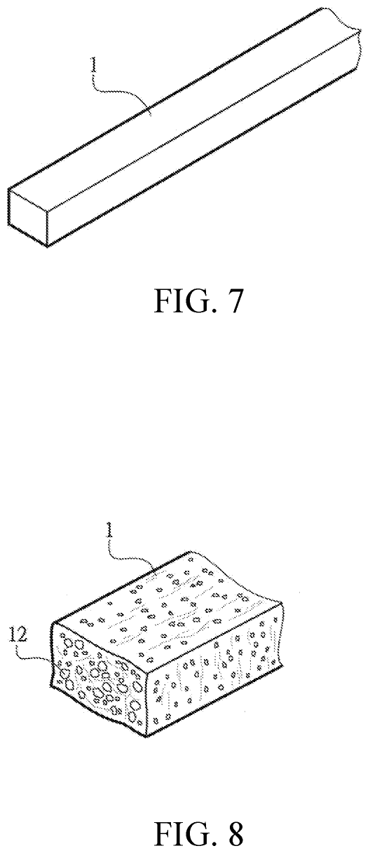

As shown in FIG. 7, the noodles 1 before drying have a smooth shape without creases and pores. Then, as shown in FIG. 8, the noodles 1 after drying would have a larger shape and there would be multiple randomly distributed larger pores 12 across the cross section. Due to their large aperture, water would quickly enter the pores and the noodles would not be too hard or overdone if the cook or soak time is not enough or too long.

As described above, the present invention has noodle base material which includes flour, semolina, or durum wheat flour mixed with water and salt. The mixture is then extruded into noodles. Depending on the thickness of the noodles and the expected cook or soak time, half-puff or fully puff drying is conducted to form instant noodles that can be quickly cooked or soaked for consumption.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A method of manufacturing instant noodles, comprising:
mixing a noodle base material, water, and salt into a mixture;
extruding the mixture into noodles of an appropriate width or a thin width;
steaming the noodles;
cutting the noodles after the noodles are steamed;
drying the noodles after they are cut, where a first stage of drying is conducted using warm air of 120° C.˜150° C. blown at speed m/s for a minute, a second stage of drying is conducted using warm air of 80° C. blown at speed 10 m/s for 36 minutes, and a third stage involves placing the noodles in a closed space for 15 minutes to achieve uniform drying; and
forming instant noodles that are easy to cook and soak.

2. The method of manufacturing instant noodles according to claim 1, wherein the mixture comprises 77% of noodle base material, 21%˜22% of water, and 1%˜2% of salt.

3. The method of manufacturing instant noodles according to claim 1, wherein the noodle base material comprises flour.

4. The method of manufacturing instant noodles according to claim 1, wherein the noodle base material comprises semolina or durum wheat flour.

5. The method of manufacturing instant noodles according to claim 1, wherein, in the steaming step, the noodles are 100% steamed.

6. A method of manufacturing instant noodles, comprising:
mixing a noodle base material, water, and salt into a mixture;
extruding the mixture into thicker and wider noodles;
steaming the noodles;
cutting the noodles after the noodles are steamed;
drying the noodles after they are cut, where a first stage of drying is conducted using warm air of 150° C.˜2000° C. blown at speed m/s for a minute, a second stage of drying is conducted using warm air of 80° C. blown at speed 10 m/s for 36 minutes, and a third stage involves placing the noodles in a closed space for 15 minutes to achieve uniform drying; and
forming instant noodles that are easy to cook and soak.

7. The method of manufacturing instant noodles according to claim 6, wherein the mixture comprises 77% of noodle base material, 21%˜22% of water, and 1%˜2% of salt.

8. The method of manufacturing instant noodles according to claim 6, wherein the noodle base material comprises flour.

9. The method of manufacturing instant noodles according to claim 6, wherein the noodle base material comprises semolina or durum wheat flour.

10. The method of manufacturing instant noodles according to claim 6, wherein, in the steaming step, the noodles are 100% steamed.
